(19) United States
(12) Patent Application Publication
(10) Pub. No.: US 2022/0295800 A1
(43) Pub. Date: Sep. 22, 2022

(54) STABLE AQUEOUS MICROBIAL COMPOSITION

(71) Applicant: BiOWiSH Technologies, Inc., Cincinnati, OH (US)

(72) Inventors: Melanie JEFFRIES, Cincinnati, OH (US); Michael Stanford SHOWELL, Cincinnati, OH (US); Anusha ADDANKI, Cincinnati, OH (US); Jessica RUSTICI-JONES, Covington, KY (US)

(21) Appl. No.: 17/631,062

(22) PCT Filed: Jul. 31, 2020
(86) PCT No.: PCT/US2020/044438

§ 371 Date: Jan. 28, 2022

Related U.S. Application Data
(60) Provisional application No. 62/888,638, filed on Aug. 19, 2019.
(60) Provisional application No. 62/881,456, filed on Aug. 1, 2019.

(51) Int. Cl. A01N 63/22; A01N 25/22

(52) U.S. Cl. CPC A01N 63/22; A01N 25/22

(57) ABSTRACT

Embodiments described herein relate generally to preservation solutions for stabilizing at least one microbial species, stable aqueous microbial compositions, and agronomic applications using the compositions described herein.

### RELATED APPLICATIONS

This application claims priority to, and the benefit of, U.S. Ser. No. 62/881,456, filed on Aug. 1, 2019, and U.S. Ser. No. 62/888,638, filed on Aug. 19, 2019, the contents of each of which are incorporated herein by reference in their entireties.

### TECHNICAL FIELD

The present disclosure relates generally to stable aqueous microbial compositions and use thereof, and methods for stabilizing aqueous microbial compositions.

### BACKGROUND

Many microbial-based agriculture formulations are delivered in either liquid or powder form, However, in practice, the commercial application of liquid microbial products poses unique challenges in achieving long-term shelf life under a range of storage and use conditions. These challenges include: (a) physical separation, where the microbial component becomes non-homogenously distributed in the package; (b) stability to environmental contaminants, especially microbial contaminants like mold and yeast; and (c) stability of the active microbial ingredients themselves under stressed storage conditions.

A number of strategies have been employed to achieve shelf stability of microbial-based agriculture products, but there remains a need for liquid microbial compositions that remain physically and biologically stable during long-term storage under a range of relevant conditions.

### SUMMARY

The present disclosure provides low cost, liquid microbial-based biostimulants or biofertilizer products that are protected against unwanted environmental microbial contaminants, including bacteria, mold, fungi, and yeast, and are biologically and physically stable across a broad range of storage conditions.

One aspect of the present disclosure relates to a stable aqueous microbial composition comprising: (a) at least one microbial species, (b) at least one preservative agent, (c) at least one suspending agent, and (d) a buffering agent in an amount sufficient to maintain the composition at a pH greater than 4.2.

In some embodiments, the composition is biologically stable at room temperature for at least a year. In some embodiments, the at least one preservative agent is in an amount sufficient to keep the composition biologically stable at room temperature for at least a year.

In some embodiments, the composition is physically stable at room temperature for at least 30 days. In some embodiments, the at least one suspending agent is in an amount sufficient to keep the composition physically stable at room temperature for at least 30 days.

In some embodiments, the composition comprises about 0.01 wt % to 10.0 wt % preservative agent. In some embodiments, the preservative agent is selected from a modified isothiazolin compound, an ester of p-hydroxybenzoic acid, a modified quaternary amine, a modified urea, a glycerin derivative, 2-bromo-2-nitro-1,3-propanediol, a natural oil, an organic acid having a molecular weight of no more than 200 and at least one pKa greater than 4.2, an inorganic salt, and a combination thereof.

In some embodiments, the modified isothiazolin compound is 1,2-benzisothiazolin-3-one, methylisothiazolinone, methylchloroisothiazoiinone, benzisothiazolinone, or a combination thereof.

In some embodiments, the ester of p-hydroxybenzoic acid is methylparaben, ethylparaben, propylparaben, or a combination thereof.

In some embodiments, the modified quaternary amine is benzethonium chloride or cetylpyridinium chloride, or a combination thereof.

In some embodiments, the modified urea is diazolidinyl urea, imidazolidinyl urea, or a combination thereof.

In some embodiments, the glycerin derivative is ethylhexylglycerin.

In some embodiments, the natural oil is grapefruit seed extract, tea tree oil, thyme oil, lemongrass oil, oregano oil, rosemary oil, lavender oil, or a combination thereof.

In some embodiments, the organic acid is acetic acid, citric acid, ascorbic acid, sorbic acid, propanoic acid, butyric acid, oxalic acid, succinic acid, malic acid, tartaric acid, futnaric acid, aconitic acid, dipicolinic acid, an amino acid, or a combination thereof.

In some embodiments, the inorganic salt is sodium chloride, potassium chloride, magnesium chloride, calcium chloride, sodium sulfate, potassium sulfate, magnesium sulfate, calcium sulfate, or a combination thereof.

In some embodiments, the modified isothiazolin compound is 1,2-benzisothiazolin-3-one. In some embodiments, the composition has about 0.01 wt % to about 1.0 wt % 1,2-benzisothiazolin-3 -one.

In some embodiments, the at least one preservative agent comprises an organic acid having a molecular weight of no more than 200 and at least one pKa greater than 4.2, and an inorganic salt, and wherein the microbial composition is suitable for use in organic farming.

In some embodiments, the composition comprises about 0.01 wt % to 10.0 wt % suspending agent. In some embodiments, the suspending agent is a polymer, a surfactant, or a combination thereof.

In some embodiments, the polymer is xanthan gum, guar gum, acacia gum, carboxymethylcellulose, sodium polyacrylate, polyethylene glycol, an ethylene oxide-propylene oxide (EO-PO) block copolymer, a modified starch, a modified polyacrylate, a modified methyl methacrylate, a polyethylene imine, sodium polyaspartate, poly-γ-glutamic acid, or a combination thereof. In some embodiments, the polymer is a blend of xanthan and acacia gums. In some embodiments, the composition has about 0.1 wt % to about 1.0 wt % the polymer.

In some embodiments, the surfactant is a primary alkyl alcohol ethoxylate, a secondary alkyl alcohol ethoxylate, a primary alkyl alcohol propoxylate, a secondary alkyl alcohol propoxylate, or a combination thereof. In some embodiments, the surfactant has a cloud point from about 30° C. to about 80° C., and hydrophilic-lipophilic balance from about 5 to about 15. In some embodiments, the surfactant is a C-13 branched primary alcohol with average ethoxylation of 5 to 10. In some embodiments, the composition has about 0.1 wt % to about 10 wt % the surfactant.

In some embodiments, the buffering agent is selected from sodium bicarbonate, sodium carbonate, calcium carbonate, a synthetic amino acid, a non-synthetic amino acid, and a combination thereof. Non-limiting examples of synthetic amino acids are the D-isomers of the amino acids such as D-alanine and D-leucine, Aib (α-aminoisobutyric acid), β-alanine, and des-amino-histidine (desH, alternative name imidazopropionic acid, abbreviated Imp).

In some embodiments, the at least one microbial species comprises at least one species selected from Bacillus, Pseudomonas, Trichoderma, Azospirillum, Azotobacter, Methylobacterium, Enterobacter, Alcaligenes, Arthrobacter, Burkholderia, and Serratia.

In some embodiments, the at least one Bacillus species is selected from Bacillus subtilis, Bacillus subtilis 34KLB, Bacillus amyloliquefaciens, Bacillus lichenformis, Bacillus pumilus, Bacillus mojavensis, Bacillus thuringiensus, Bacillus cereus, Bacillus megaterium, and a combination thereof.

In some embodiments, the at least one Bacillus species is a combination of Bacillus subtilis, Bacillus amyloliquefaciens, Bacillus licheniformis, and Bacillus pumilus. In some embodiments, Bacillus subtilis, Bacillus amyloliquelaciens, Bacillus licheniformis, and Bacillus pumilus are present at equal colony-forming unit (CFU) count per milliliter of the composition.

In some embodiments, the at least one Pseudomonas species is selected from Pseudomonas fluorescens, Pseudomonas putida, Pseudomonas aeruginosa, and a combination thereof.

In some embodiments, the composition has a microbial concentration of at least 1×10⁹ CFU/mL.

In some embodiments, the composition is at a pH of about 4.3 to about 8.5.

The composition described herein can be coated onto a fertilizer or seeds for rice, corn, soybean, onion, sugar cane, tomato, barley, lettuce, wheat, potato, legumes, or grass.

Another aspect of the present disclosure relates to a fertilizing composition comprising a fertilizer coated with the stable aqueous microbial composition described herein. In some embodiments, the fertilizer is an organic fertilizer. In some embodiments, the organic fertilizer comprises fish meal, bird guano, livestock manure, compost, and rock phosphate.

Another aspect of the present disclosure relates to a method for stabilizing at least one microbial species in an aqueous microbial composition, the method comprising adding to the aqueous microbial composition (a) at least one preservative agent, (b) at least one suspending agent, and (c) a buffering agent in an amount sufficient to maintain the composition at a pH greater than 4.2.

Another aspect of the present disclosure relates to a method for fertilizing a crop, the method comprising contacting the crop with the stable aqueous microbial composition described herein. In some embodiments, the crop is an organic crop. In some embodiments, the crop is selected from rice, corn, soybean, onion, sugar cane, tomato, potato, barley, wheat, legume, lettuce, and grass. In some embodiments, the crop is contacted with the stable aqueous microbial composition 1-3 times during growth season. In some embodiments, contacting the crop comprises applying the aqueous microbial composition to soil and/or an irrigation system. In some embodiments, the method further comprises mixing the aqueous microbial composition with a fertilizer prior to contacting the crop.

### BRIEF DESCRIPTION OF THE DRAWINGS

FIG. 1 is a graph showing stability of a 1:1:1:1 liquid mixture of B. subtilis, B. amyloliquefaciens, B. licheniformis, and B. pumilus endospores as a function of pH.

FIG. 2 is a graph showing inhibition of contaminating yeasts and gram-negative bacteria in a liquid Bacillus mixture as a function of NaCl level.

FIGS. 3A-3C are a series of graphs comparing the effects of different surfactants on stability. BW283=B. amyloliquefaciens, BW284=B. subtilis, BW285=B. pumilus, BW286=B. licheniformis. After room temperature storage for 133 days, both physical stability and total bacterial titer results were considered. Formulations containing Synperonic™-13/6 or 2-ethyl-hexanol-alkoxylate (EcosurfrM EH-6) lead to good physical stability.

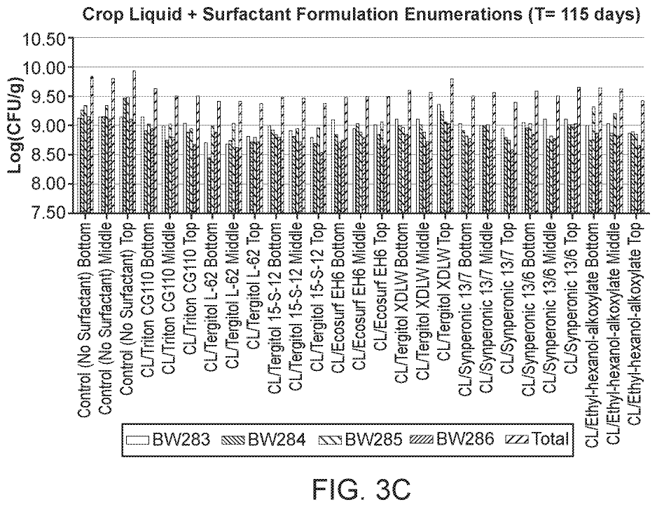

### DETAILED DESCRIPTION

The present disclosure relates to aqueous compositions that are formulated to preserve and physically stabilize microbial spores and/or colonies across a broad range of storage conditions for a period of time. Advantages of aqueous microbial compositions include low costs and ease of use. In some aspects, the present disclosure relates to liquid biostimulant and biofertilizer products for application to soil or foliage and to methods of improving soil and plant productivity and quality. Compositions of the present disclosure can stimulate plant growth, improve soil productivity and soil fertility, and promote the growth of beneficial soil microbes.

One aspect of the present disclosure relates to a preservation solution for stabilizing at least one microbial species, the preservation solution includes at least one preservative agent, at least one suspending agent, and a buffering agent in an amount sufficient to maintain the preservation solution at a pH greater than 4.2.

A related aspect of the present disclosure relates to a stable aqueous microbial composition comprising: (a) at least one microbial species, (b) at least one preservative agent, (c) at least one suspending agent, and (d) a buffering agent in an amount sufficient to maintain the composition at a pH greater than 4.2. The stable aqueous microbial composition can remain biologically and physically stable at room temperature for a period of time. Notably, the stable aqueous microbial composition can have long-term stability when stored under a range of commercially relevant temperature and humidity conditions.

In some embodiments, the stable aqueous microbial composition can remain biologically stable at about 20° C. to about 40° C. for at least 6 months, at least 7 months, at least 8 months, at least 9 months, at least 10 months, at least 11 months, at least a year, at least 1.5 years, or at least 2 years. In some embodiments, the stable aqueous microbial composition can remain biologically stable at about 20° C. to about 40° C. for about 6 months to about 3 years, e.g., about 6 months to about 2 years, about 6 months to about 1.5 years, about 6 months to about 1 year, about 1 year to about 3 years, about 1 year to 2 years, or about 1 year to 1.5 years. For example, the table aqueous microbial composition can remain biologically stable at about 20° C. to about 40 for about 6 months, about 9 months, about a year, about 1.5 years, or about 2 years.

In some embodiments, the stable aqueous microbial composition can remain biologically stable at room temperature for at least 6 months, at least 7 months, at least 8 months, at least 9 months, at least 10 months, at least 11 months, at least a year, at least 1.5 years, or at least 2 years. In some embodiments, the stable aqueous microbial composition can remain biologically stable at room temperature for about 6 months to about 3 years, e.g., about 6 months to about 2 years, about 6 months to about 1.5 years, about 6 months to about 1 year, about 1 year to about 3 years, about 1 year to 2 years, or about 1 year to 1.5 years. For example, the stable aqueous microbial composition can remain biologically stable at room temperature for about 6 months, about 9 months, about a year, about 1.5 years, about 2 years, about 2.5 years, or about 3 years.

In some embodiments, the stable aqueous microbial composition can remain physically stable at about 20° C. to about 40° C. for at least 10 days, at least 20 days, at least 30 days, at least 40 days, at least 50 days, or at least 60 days. In some embodiments, the stable aqueous microbial composition can remain physically stable at about 20° C. to about 40° C. for about 30 days to about 365 days, e.g., about 30 days to 270 days, or about 30 days to 180 days. For example, the stable aqueous microbial composition can remain physically stable at about 20° C. to about 40° C. for about 30 days, about 60 days, about 90 days, or about 120 days.

In some embodiments, the stable aqueous microbial composition can remain physically stable at room temperature for at least 10 days, at least 20 days, at least 30 days, at least 40 days, at least 50 days, or at least 60 days. In some embodiments, the stable aqueous microbial composition can remain physically stable at room temperature for about 30 days to about 365 days, e.g., about 30 days to 270 days, or about 30 days to 180 days. For example, the stable aqueous microbial composition can remain physically stable at room temperature for about 30 days, about 60 days, about 90 days, or about 120 days.

The stable aqueous microbial composition can remain biologically and/or physically stable for the aforementioned periods of time under a variety of humidity conditions. In some embodiments, the relative humidity (RH) is ambient. In some embodiments, the RH is about 10% to about 90%, e.g., about 10% to about 80%, about 10% to about 75%, about 10% to about 70%, about 10% to about 65?, about 10% to about 60%, about 20% to about 90%, about 20% to about 80%, about 20% to about 75?, about 20% to about 70%, about 20% to about 65%, about 20% to about 60%, about 30% to about 90?, about 30% to about 80%, about 30% to about 75%, about 30% to about 70%, about 30% to about 65%, or about 30% to about 60%. In some embodiments, the RH is about 10%, about 15%, about 20%, about 25%, about 30%, about 35%, about 40%, about 45%, about 50%, about 55?, about 60%, about 65%, or about 70%.

The preservation solution or stable aqueous microbial composition can include about 0.01 wt % to 15.0 wt % preservative agent, e.g., about 0.01 wt % to 10.0 wt %, about 0.01 wt % to 5.0 wt %, about 0.01 wt % to 3,0 wt %, about 0.01 wt % to 1.0 wt %, about 0,1 wt % to 15.0 wt %, about 0.1 wt % to 10.0 wt %, about 0.1 wt % to 5,0 wt %, about 0.1 wt % to 3.0 wt %, about 0.1 wt % to 1.0 wt %, about 0.5 wt % to 15.0 wt %, about 0,5 wt % to 10.0 wt %, about 0.5 wt % to 5.0 wt %, about 0.5 wt % to 3.0 wt %, about 0,5 wt % to 1,0 wt %, about 1.0 wt % to 15.0 wt %, about 1.0 wt % to 10.0 wt %, about 1.0 wt % to 5.0 wt %, or about 1.0 wt % to 3.0 wt % preservative agent.

The preservation solution or stable aqueous microbial composition can include one preservative agent, two preservative agents, three preservative agents, or more.

The preservative agent can be selected from a modified isothiazolin compound, an ester of p-hydroxybenzoic acid, a modified quaternary amine, a modified urea, a glycerin derivative. 2-bromo-2-nitro-1,3-propanediol, a natural oil, an organic acid having a molecular weight of no more than 200 and at least one pKa greater than 4.2., an inorganic salt, and a combination thereof.

Examples of modified isothiazolin compounds include, but are not limited to, 1,2-benzisothiazolin-3-one, methy lisothiazolinone, methylchloroisothiazolinone, benzisothiazolinone, and a combination thereof.

Examples of esters of p-hydroxybenzoic acid include, but are not limited to, methylparaben, ethylparaben, propylparaben, and a combination thereof.

Examples of modified quaternary amines include, but are not limited to, benzethonium chloride or cetylpyridinium chloride, and a combination thereof.

Examples of modified urea include, but are not limited to, diazolidinyl urea, imidazolidinyl urea, and a combination thereof.

Examples of glycerin derivatives include, but are not limited to, ethylhexylglycerin.

Examples of natural oils include, but are not limited to, grapefruit seed extract, tea tree oil, thyme oil, lemongrass oil, oregano oil, rosemary oil, lavender oil, and a combination thereof.

Examples of organic acids include, but are not limited to, acetic acid, citric acid, ascorbic acid, sorbic acid, propanoic acid, butyric acid, oxalic acid, succinic acid, malic acid, tartaric acid, fumaric acid, aconitic acid, dipicolinic acid, an amino acid, and a combination thereof.

Examples of amino acids include, but are not limited to, alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine.

Examples of inorganic salts include, but are not limited to, sodium chloride, potassium chloride, magnesium chloride, calcium chloride, sodium sulfate, potassium sulfate, magnesium sulfate, calcium sulfate, and a combination thereof.

In some embodiments, the preservation solution or stable aqueous microbial composition includes from about 0.1 wt % to about 1 wt % calcium sulfate and from about 0.1 wt % to about 10 wt % sodium chloride.

In some embodiments, the preservative agent includes 1,2-benzisothiazolin-3-one. In some embodiments, the preservation solution or stable aqueous microbial composition includes about 0.01 wt % to about 2.0 wt %, about 0.01 wt % to about 1.5 wt %, about 0.01 wt % to about 1.0 wt %, or about 0.05 wt % to about 1.0 wt % 1,2-benzisothiazolin-3-one.

In some embodiments, the preservation solution or stable aqueous microbial composition can include about 0.01 wt % to about 0.2 wt % modified benzisothiazolin, p-hydroxybenzoic ester, modified urea, or mixtures thereof, about 0.05 wt % to about 1 wt % low molecular weight organic acid, and/or about 0.1 wt % to about 10 wt % inorganic salt. In some embodiments, the preservation solution or stable aqueous microbial composition can include about 0.01 wt % to about 0.1 wt % 1,2-benzisothiazolin-3-one, about 0.1 wt % to about 1 wt % sorbic acid, and about 0.1 wt % to 10 wt % sodium chloride.

The preservation solution or stable aqueous microbial composition can include about 0.01 wt % to 15.0 wt % suspending agent, e.g., about 0.01 wt % to 10.0 wt %, about 0.01 wt % to 5.0 wt %, about 0.01 wt % to 3.0 wt %, about 0.01 wt % to 1.0 wt %, about 0.1 wt % to 15.0 wt %, about 0.1 wt % to 10.0 wt %, about 0.1 wt % to 5.0 wt %, about 0.1 wt % to 3.0 wt %, about 0.1 wt % to 1.0 wt %, about 0.1 wt % to 0.5 wt %, about 0.1 wt % to 0.4 wt %, about 0.5 wt % to 15.0 wt %, about 0.5 wt % to 10.0 wt %, about 0.5 wt % to 5.0 wt %, about 0.5 wt % to 3.0 wt %, about 0.5 wt % to 1.0 wt %, about 1.0 wt % to 15.0 wt %, about 1.0 wt % to 10.0 wt %, about 1.0 wt % to 5.0 wt %, or about 1.0 wt % to 3.0 wt % suspending agent.

The preservation solution or stable aqueous microbial composition can include one suspending agent, two suspending agents, three suspending agents, or more. The suspending agent is used, inter alia, for suspending the microbes in the aqueous composition, thereby providing the desirable physical stability. Without wishing to be bound by theory, the suspending agent can modify the viscosity of the aqueous composition, thereby preventing settling of the microbial species to the bottom of a container.

The suspending agent can be a polymer, a surfactant, or a combination thereof. In some embodiments, the suspending agent is a polymer. Examples of polymers can include, but are not limited to, xanthan gum, guar gum, acacia. gum, carboxymethylcellulose, sodium polyacrylate, polyethylene glycol, an ethylene oxide-propylene oxide (EO-PO) block copolymer, a modified starch, a modified polyacrylate, a modified methyl methacrylate, a polyethylene imine, sodium polyaspartate, poly-γ-glutamic acid, or a combination thereof. In some embodiments, the suspending agent is a blend of xanthan and acacia gums (e.g., Solagum™ AX). In some embodiments, the preservation solution or stable aqueous microbial composition can include about 0.1 wt % to 1.0 wt % polymer.

The nature of Bacillus spores revealed that they are hydrophobic in nature due to the nature of their spore coat. Hence, they clump together and stick to the walls of the container. The addition of an appropriate surfactant can aid steric stabilization of the suspension, by preventing the spores from clumping together.

Examples of surfactants include, but are not limited to, a primary alkyl alcohol ethoxylate, a secondary alkyl alcohol ethoxylate, a primary alkyl alcohol propoxylate, a secondary alkyl alcohol propoxylate, and a combination thereof. In some embodiments, the surfactant has a cloud point from about 30° C. to about 80° C., and hydrophilic-lipophilic balance from about 5 to about 15. In some embodiments, the surfactant is a C-13 branched primary alcohol with average ethoxylation of 5 to 10, e.g., 5, 6, 7, 8, 9, or 10.

In some embodiments, the surfactant includes an ethoxylated primary branched C13 alcohol with full saturation, such as Synperonic™ 13/7 or Synperonic™ 13/6.

In some embodiments, the surfactant includes alcohol ethoxylate, such as Ecosurf™ EH-6.

In some embodiments, the surfactant includes a mixture of 58.0-62.0% D-glucopyranose, oligomeric, decyl octyl glycoside and 38.0-42.0% water, and contains less than 2% decanol and less than 1.0% octanol, such as Triton™ CG110.

In some embodiments, the surfactant includes secondary polyether polyol, such as Tergitol™ L-62.

In some embodiments, the surfactant includes secondary alcohol ethoxylate, such as Tergitol™ 15-S-12.

In some embodiments, the surfactant includes a non-ionic alkyl EO/PO copolymer, such as Tergitol™ XDLW.

In some embodiments, the suspending agent can include xanthan gum, acacia gum, and alcohol ethoxylate.

In some embodiments, the preservation solution or stable aqueous microbial composition can include about 0.1 wt % to 10 wt % surfactant, e.g., about 0.1 wt % to 5 wt %, 0.1 wt % to 2 wt %, 0.1 wt % to 1 wt %, 0.5 wt % to 1 wt %, or 0.5 wt % to 2 wt % surfactant.

The preservation solution or stable aqueous microbial composition can include about 0.01 wt % to 15.0 wt % buffering agent, e.g., about 0.01 wt % to 10.0 wt %, about 0.01 wt©© to 5.0 wt %, about 0.01 wt % to 3.0 wt %, about 0.01 wt % to 1.0 wt %, about 0.1 wt % to 15.0 wt %, about 0.1 wt % to 10.0 wt %, about 0.1 wt % to 5.0 wt %, about 0.1 wt % to 3.0 wt %, about 0.1 wt % to 1.0 wt %, about 0.5 wt % to 15.0 wt %, about 0.5 wt % to 10.0 wt %, about 0.5 wt % to 5.0 wt %, about 0.5 wt % to 3.0 wt %, about 0.5 wt % to 1.0 wt %, about 1.0 wt % to 15.0 wt %, about 1.0 wt % to 10.0 wt %, about 1.0 wt % to 5.0 wt %, or about 1.0 wt % to 3.0 wt % buffering agent.

The buffering agent can be in an amount sufficient to keep the pH of the preservation solution or stable aqueous microbial composition at greater than 4.2, e.g., greater than 4.5, greater than 5.0, greater than 5.5, greater than 6.0, greater than 6.5, or greater than 7.0. In some embodiments, the buffering agent can be in an amount sufficient to keep the pH of the preservation solution or stable aqueous microbial composition in the range of about 4.3 to about 12.0, e.g., about 4.3 to about 11.0, about 4.3 to about 10.0, about 4.3 to about 9.5, about 4.3 to about 9.0, about 4.3 to about 8.5, about 5.0 to about 12.0, about 5.0 to about 11.0, about 5.0 to about 10.0, about 5.0 to about 9.5, about 5.0 to about 9.0, about 5.0 to about 8.5, about 5.5 to about 12.0, about 5.5 to about 11.0, about 5.5 to about 10.0, about 5.5 to about 9.5, about 5.5 to about 9.0, or about 5.5 to about 8.5.

The pH of the aqueous composition is selected to maximize shelf life of the spores and/or colonies stored in the aqueous composition for extended periods. pH's less than about 4 may have a detrimental effect on stability of certain bacterial spores at elevated temperatures. For example, Bacillus spores can demineralize at low pH, losing their resistance to high temperature storage. Therefore, a pH greater than about 4.2 is desirable for improving the biological stability of Bacillus spores.

The preservation solution or stable aqueous microbial composition described herein can be used for any type of farming, such as organic farming and non-organic farming.

Agricultural products designed for use in organic farm applications must meet stringent requirements with respect to the ingredients used, production and processing (www.usda.gov/media/blog/2012/01/25/organic-101-allowed-and-prohibited-substances). For example, most synthetic fertilizers, pesticides, herbicides, and genetically modified organisms are prohibited from use on organic farms. To be certified organic, all ingredients and processing aids must meet specific organic certification criteria, unless specifically allowed by the certifying organization.

In order to be suitable for organic farming, the preservative agent, suspending agent, and buffering agent in the preservation solution or stable aqueous microbial composition described herein need to be organically certified. Some embodiments of the stable aqueous microbial composition meet the organic certification requirements of the United States Department of Agriculture (USDA), the Organic Materials Review Institute (OMRI), and/or the Washington State Department of Agriculture (WSDA).

The organically certified preservative agent can be an organically certified low molecular weight organic acid with at least one pKa greater than about 4.2, such as acetic acid, citric acid, ascorbic acid, sorbic acid, propanoic acid, butyric acid, oxalic acid, succinic acid, malic acid, tartaric acid, fumaric acid, aconitic acid, dipicolinic acid, a naturally occurring amino acid, and a synthetic amino acid. In some embodiments, the organic acid is acetic acid, citric acid, ascorbic acid, or sorbic acid.

The organically certified preservative agent can be an organically certified inorganic salt, such as sodium chloride, potassium chloride, magnesium chloride, calcium chloride, sodium sulfate, potassium sulfate, magnesium sulfate, and calcium sulfate. In some embodiments, the inorganic salt is sodium chloride, sodium sulfate, or magnesium chloride.

In some embodiments, the organically certified preservative agent can include an organic acid having a molecular weight of no more than 200 and at least one pKa greater than 4.2, and an inorganic salt.

The organically certified suspending agent can include xanthan gum and acacia gum, such as SOLAGUM™ AX.

The organically certified buffering agent can be sodium bicarbonate, sodium carbonate, calcium carbonate, a synthetic amino acid, or a non-synthetic amino acid. In some embodiments, the buffering agent is sodium bicarbonate, glycine, or calcium carbonate.

In some embodiments, the preservation solution or stable aqueous microbial composition suitable for organic farming can include either one of the mixtures in Table 1 and have the corresponding pH range.

TABLE 1

| Mixture | Organic Acid | Inorganic Salt | Buffering | pH |
|---|---|---|---|---|
| No. | Component | Component | Agent | Range |
| 1 | Sorbic Acid | NaCl | NaHCO₃ | 4.5-5.5 |
| 2 | Sorbic Acid | MgCl₂ | NaHCO₃ | 4.5-5.5 |
| 3 | Sorbic Acid | Na₂SO₄ | Glycine | 4.5-5.5 |
| 4 | Citric Acid | NaCl | NaHCO₃ | 4.5-6.0 |
| 5 | Acetic Acid | NaCl | CaCO₃ | 4.3-6.0 |
| 6 | Ascorbic Acid | NaCl | NaHCO₃ | 4.3-6.0 |

In some embodiments, the stable aqueous microbial composition can include about 1 wt % to about 30 wt % the at least one microbial species, e.g., about 1 wt % to about 25 wt %, about 1 wt % to about 20 wt %, about 1 wt % to about 15 wt %, about 1 wt % to about 10 wt %, about 5 wt % to about 30 wt %, about 5 wt©© to about 25 wt %, about 5 wt % to about 20 wt %, about 5 wt % to about 15 wt %, or about 5 wt % to about 10 wt %.

In some embodiments, the at least one microbial species is suitable for promoting plant growth, promoting plant health, improving crop yield, and/or improving soil quality. For example, the at least one microbial species can grow under a range of agriculturally relevant conditions and can colonize either the soil, the plant roots, or both. These include, but are not limited to, bacteria, e.g., Bacillus species such as Bacillus subtilis, Bacillus subtilis 34KLB, Bacillus amyloliquefaciens, Bacillus licheniforms, Bacllus pumilus, Bacillus megaterium, Bacillus fungi, Bacillus mucilaginosus, Bacillus cereus, and Bacillus penetrans; fungi, e.g., Trichoderma species such as Trichoderma hamatum, Trichoderma harzianum, Tridhoderma polysporum, Trichoderma konigii, and Trichoderma viride; and yeast species, e.g., Saccharomyces cerevisiae. The sequences for Bacillus subtilis 34KLB can be found in US2020/0085069, the contents of which are incorporated herein by reference.

In some embodiments, the at least one microbial species comprises at least one species selected from Bacillus, Pseudomonas, Trichoderma, Azospirillum, Azotobacter, Methylobacterium, Enterobacter, Alcaligenes, Arthrobacter, Burkholderia, and Serratia.

Examples of Bacillus include, but are not limited to, Bacillus subtilis, Bacillus subtilis 34KLB, Bacillus amyloliquefaciens, Bacillus licheniformis, Bacillus pumilus, Bacillus mojavensis, Bacillus thuringiensus, Bacillus cereus, Bacillus megaterium, and a combination thereof. In some embodiments, the at least one microbial species comprises a combination of Bacillus subtilis, Bacillus amyloliquefaciens, Bacillus licheniformis, and Bacillus pumilus, which can be present at any ratio. In some embodiments, Bacillus subtilis, Bacillus amyloliquefaciens, Bacillus licheniformis, and Bacillus pumilus are present at equal colony-forming unit (CFU) count per milliliter of the composition.

Examples of Pseudomonas include, but are not limited to, Pseudomonas fluorescens, Pseudomonas putida, Pseudomonas aeruginosa, and a combination thereof.

The microbial species can be produced by any of the common methods known in the art. For example, they can be grown via submerged fermentation processes and recovered by filtration/centrifugation. Alternatively, they can be grown via solid substrate fermentation. In some embodiments, the production process involves submerged fermentation of each microbe, collection of the fermentation broth and mixing to give a liquid product with total bacterial activity between about 1×10⁶ CFU/mL and 1×10¹² CFU/mL. In some embodiments, the individually fermented microbes are harvested by methods known in the art, such as ultrafiltration, then dried, e.g., either by spray drying or freeze drying.

The stable aqueous microbial composition can be produced by mixing at least one microbial species with the preservation solution described herein. The individual dried microbes can be added to the preservation solution to deliver the desired end-use benefits.

In some embodiments, spores or whole microorganisms, including harvested and/or lyophilized microbial colonies containing spores, are added to the preservation solution, which promotes long-term storage stability across a broad range of conditions. The solutions can be formulated for use in agricultural applications requiring viable microbial spores and/or colonies. Water miscible dry powders and/or granules such as lyophilized preparations of spores and/or colonies are preferred in many embodiments. The quantity of spores and/or colonies added to the solutions of the invention does not need to be fixed, and can be dependent upon the microbial titer required to achieve the end-use benefit. Preferred embodiments employ spores and/or colonies in amounts effective to achieve plant growth and vigor beyond what is achieved with standard grower fertility practices. The stable aqueous microbial composition has a microbial concentration from about 1×10⁶ to about 1×10¹² CFU/mL, e.g., 1×10⁶ to about 1×10¹¹ CFU/mL, about 1×10⁸ to 1×10¹² or about 1×10⁹ to 1×10¹² CFU/ML. In some embodiments, the stable aqueous microbial composition has a microbial concentration greater than 1×10⁹CFU/mL. Bacillus counts can be obtained on Trypticase soy agar.

In some embodiments, the stable aqueous microbial composition includes a mixture of Bacillus endospores suspended in an aqueous medium of pH greater than about 4.2, about 0.1 wt % to 1 wt % polymeric suspending agent, about 0.1 wt % to 5 wt % surfactant, and about 0.1 wt % to 10 wt % preservative agent.

In some embodiments, the stable aqueous microbial composition includes: (a) about 1 wt % to about 10 wt % mixture of Bacillus subtilis, Bacillus amyloliquefaciens, Bacillus licheniformis, and Bacillus pumilus; (b) about 1 wt % to about 5 wt % C-13 branched primary alcohol with average ethoxylation of 7; (c) about 0.1 wt % to about 0.5 wt % blend of xanthan and acacia gums; (d) about 1 wt % to about 10 wt % sodium chloride; (e) about 0.01 wt % to 0.2 wt % 1,2-benzisothiazolin-3-one; (f) about 0.1 wt % to about 1 wt % calcium sulfate, wherein the composition has a pH greater than about 4.2. In some embodiments, Bacillus subtilis, Bacillus amyloliquefaciens, Bacillus licheniformis, and Bacillus pumilus are mixed at a 1:1:1:1 ratio on an activity basis, having a microbial concentration of about 1×10⁶ CFU/mL to 1×10¹¹ CFU/mL.

In some embodiments, the stable aqueous microbial composition can include: (a) a mixture of Bacillus subtilis, Bacillus amyloliquefaciens, Bacillus licheniformis, and Bacillus pumilus, (b) about 0.01 wt % to 1.0 wt % sorbic acid, (c) about 5 wt % to 10 wt % sodium chloride, and (d) sodium bicarbonate, wherein the microbial composition has a pH in the range of 4.5 and 9.0. In some embodiments, Bacillus subtilis, Bacillus amyloliquefaciens, Bacillus licheniformis, and Bacillus pumilus are mixed at a 1:1:1:1 ratio on an activity basis, wherein each Bacillus species is added at a level of at least 1×10⁹ CFU/mL. Such composition can be suitable for organic farming.

In some embodiments, the stable aqueous microbial composition can include: (a) a mixture of Bacillus subtilis, Bacillus amyloliquefaciens, Bacillus licheniformis, and Bacillus pumilus, (b) about 0.01 wt % to 1.0 wt % sorbic acid, (c) about 5 wt % to 10 wt % sodium chloride, and (d) sodium bicarbonate, wherein the microbial composition has a pH of about 5.0. In some embodiments, Bacillus subtilis, Bacillus amyloliquefaciens, Bacillus licheniformis, and Bacillus pumilus are mixed at a 1:1:1:1 ratio on an activity basis, wherein the total Bacillus titer is at least 4×10¹⁰ CFU/mL. Such composition can be suitable for organic farming.

In some embodiments, the stable aqueous microbial composition can include: (a) a mixture of Bacillus subtilis, Bacillus amyloliquefaciens, Bacillus licheniformis, and Bacillus pumilus, (b) about 0.1 wt % to about 0.5 wt % gypsum, (c) about 0,01 wt % to 1.0 wt % sorbic acid, (d) about 2 wt % to 10 wt % sodium chloride, and (e) sodium bicarbonate, wherein the microbial composition has a pH greater than 4.2. In some embodiments, Bacillus subtilis, Bacillus amyloliquefaciens, Bacillus licheniformis, and Bacillus pumilus are mixed at a 1:1:1:1 ratio on an activity basis, wherein each Bacillus species is dosed at about 1×10⁹ CFU/mL. Such composition can be suitable for organic farming.

The stable aqueous microbial composition of the present disclosure can be used as biostimulants and components of enhanced efficiency fertilizers in agronomy applications to promote plant health and vigor and improve crop yield. It can be applied to soil after being coated onto carriers or via irrigation/chemigation processes, or via tank mixed with other agrochemicals. For example, the stable aqueous microbial composition may be coated onto common fertilizer particles such as urea, monoammonium and diammonium phosphate, ammonium sulfate, compound and blended NPK's, and biosolids. The resulting coated fertilizer particles can then be field applied via standard fertilization practices. Alternatively, the stable aqueous microbial composition may be mixed with liquid fertilizers and applied as part of a standard fertilization regimen. The stable aqueous microbial composition may be combined with other agrochemicals such as fungicides, herbicides, or insecticides in a tank mix and applied via spray application. The stable aqueous microbial composition may also be applied via foliar application.

In some embodiments, the stable aqueous microbial composition described herein can be coated onto seeds of any plant including, but not limited to, rice, corn, soybean, onion, sugar cane, tomato, barley, lettuce, wheat, potato, legumes, or grass.

Another aspect of the present disclosure relates to a fertilizing composition comprising a fertilizer coated with the stable aqueous microbial composition described herein. In some embodiments, the fertilizer is an organic fertilizer. In some embodiments, the organic fertilizer includes fish meal, bird guano, livestock manure, compost, and rock phosphate. In yet another embodiment, liquid compositions of the present invention are added to liquid fertilizers certified for use in organic farming (e.g. Phytamin™, Phyta-QC™, Tridents Pride, etc.) and the subsequent blended liquid is used as part of an organic crop fertility program.

Another aspect of the present disclosure relates to a method for fertilizing a crop, the method including contacting the crop with the stable aqueous microbial composition. In some embodiments, the crop is an organic crop. In some embodiments, the crop is not an organic crop. Examples of crops include, but are not limited to, rice, corn, soybean, onion, sugar cane, tomato, potato, barley, wheat, legume, lettuce, and grass. In some embodiments, the crop is contacted with the stable aqueous microbial composition at least once during growth season, e.g., 1-3 times. In some embodiments, contacting the crop comprises applying the aqueous microbial composition to soil, an irrigation system, and/or the leaves of the crop. In some embodiments, the method further comprises mixing the aqueous microbial composition with a fertilizer prior to contacting the crop.

When used in agronomic applications, the stable aqueous microbial compositions of the present disclosure can provide a number of desirable characteristics related to soil health and improvement of soil quality, such as increased nutrient availability, increased organic matter content, decreased compaction, and improved moisture retention. The stable aqueous microbial compositions can also provide a number of desirable characteristics related to plant health and vigor including, but not limited to, improved nutrient uptake, improved abiotic stress tolerance, and increased crop yield.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially”, “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, t© at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” refers to weight percent.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “biologically stable” refers to the microbial titer of an aqueous microbial composition changing no more than 25% (e.g., no more than 20%, no more than 15%, or no more than 10%) upon storage at room temperature for a period of time, e.g., at least 6 months.

As used herein, the term “physically stable” refers to the microbial titer deviating by no more than 25% (e.g., no more than 20%, no more than 15%, or no more than 10%) throughout an aqueous microbial composition for a period of time absent any physical agitation, such as shaking, rocking, and inverting. In some embodiments, to determine physical stability, the top, middle, and bottom portions of an aqueous microbial composition can be assayed for microbial titer; and the composition is deemed physically stable when the microbial titer for each portion does not differ by more than 25%. In some embodiments, the period of time absent any physical agitation is at least 10 days.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

### Example 1

### Preparation of Bacillus endospores

The microbes of the present disclosure can be grown using standard submerged liquid fermentation processes known in the art.

Individual starter cultures of Bacillus subtilis, Bacillus licheniformis, Bacillus amyloliquefaciens, and Bacillus pumilus are grown according to the following general protocol and adapted as required for each organism: 2 grams Nutrient Broth, 2 grams AmberFerm (yeast extract) and 4 grams maltodextrin are added to a 250 mL Erlenmeyer flask. 100 mLs distilled, deionized water are added and the flask is stirred until all dry ingredients dissolve. The flask is covered and placed for 30 minutes in an autoclave operating at 121° C. and 15 psi. After cooling, the flask is inoculated with 1 mL of one of the pure microbial strains. The flask is sealed and placed on an orbital shaker at 30° C. Cultures are allowed to grow for 3-5 days. This procedure is repeated for each organism.

Larger cultures are prepared by adding 18 grains Nutrient Broth, 18 grams AmberFerm, and 36 grams maltodextrin to 1-liter flasks with 900 mLs distilled, deionized water. The flasks are sealed and sterilized as above. After cooling, 100 mLs of the microbial media from the 250 mL Erlenmeyer flasks are added. The 1-liter flasks are sealed, placed on an orbital shaker, and allowed to grow for another 3-5 days at 30° C.

In the final grow-out phase before introduction to the fermenter, cultures from the 1-liter flasks are transferred under sterile conditions to sterilized 6-liter vessels and fermentation continued at 30° C. with aerating until stationary phase is achieved. The contents of each 6-liter culture flask are transferred to individual fermenters which are also charged with a sterilized growth media made from 1 part yeast extract and 2 parts dextrose. The individual fermenters are run under aerobic conditions operating at pH 7.0 and the temperature optimum for each species.

Once cell density reaches 10¹¹CFU/mL, the fermenters are heat shocked at >80° C. to induce spore formation. Spores are recovered from the liquid fermentation media via filtration then resuspended in an aqueous medium at a titer of about 10¹¹ CFU/mL. Each stock aqueous suspension of pure Bacillus spores is stored cold (˜4° C.).

A Bacillus concentrate with a final titer greater than about 40×10¹⁰ GU/mL is prepared by mixing the individual stock aqueous suspensions of Bacillus subtilis, Bacillus licheniformis, Bacillus amyloliquefaciens, and Bacillus pumilus into an aqueous medium stabilized with 0.25 wt % calcium sulfate.

### Example 2

### Effect of pH on Bacillus endospore Stability

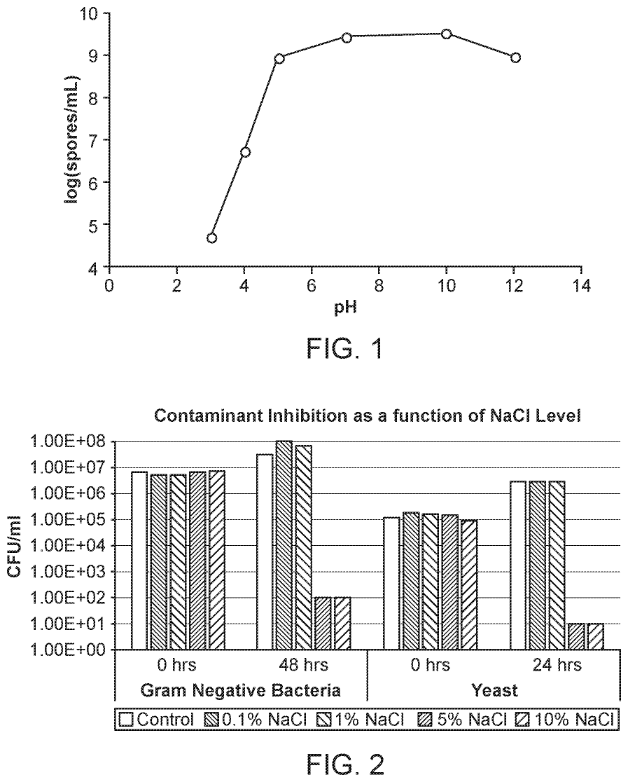

An aqueous composition comprising 10 w of the Bacillus mixture from Example 1, 0.25 wt % calcium sulfate (as gypsum), and 1 wt % acetic acid was prepared and divided into 6 equal aliquots. Each aliquot was subsequently pH adjusted with sodium hydroxide then assayed for spore count using the standard FDA BALI Chapter 3 method which includes a pasteurization step of 80° C. heating for 10 minutes to kill off vegetative cells. This method only counts surviving spores. Results are shown in FIG. 1. Spore recovery drops off significantly below pH 5.

### Example 3

### Effect of Salt Concentration on Inhibiting Contaminating Microbes

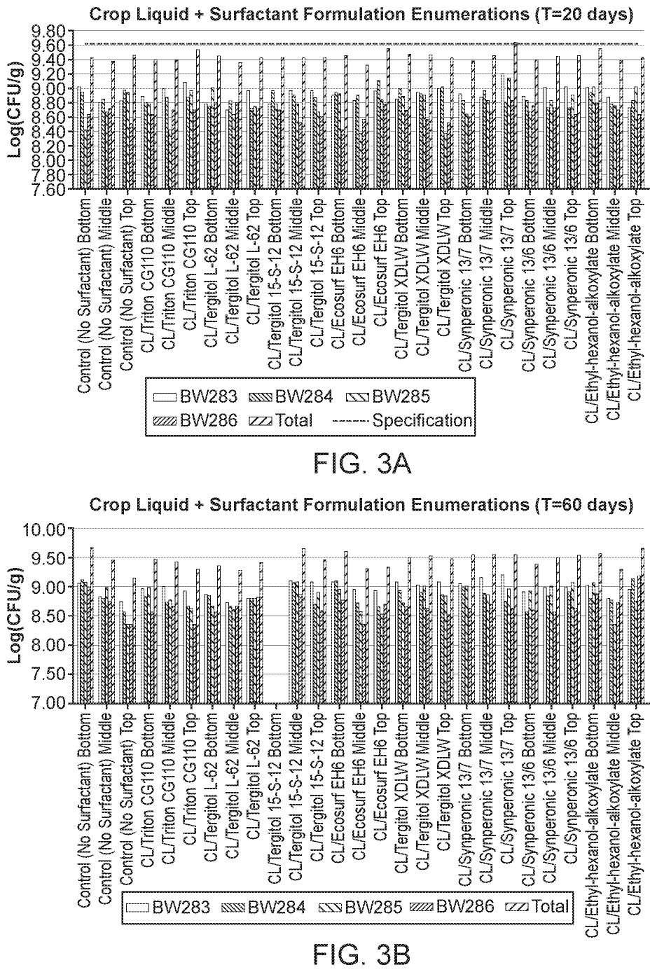

An aqueous composition comprising 10 wt % of the Bacillus mixture from Example 1, 0.25 wt % calcium sulfate (as gypsum), pH adjusted to about pH 6 with sodium bicarbonate. This composition was divided into five equal aliquots and different levels of NaCl added to the individual aliquots. The aliquots were then dosed with an inoculum of yeasts (C. albicans, C. orthopsilensis, S. cervisiae) at about 1×10⁵ CFU/mL and an inoculum of Gram-negative bacteria (P. aeruginosa, P. taiwanensis) at about 1×10⁶ CFU/mL. The aliquots were then incubated at 35° C. for up to 48 hours and the titer of contaminating microbes assessed. Results are shown in FIG. 2. Significant reductions in both the contaminating yeast and Gram-negative bacterial titers were observed for NaCl levels greater than or equal to 5%. There was no effect on recovered Bacillus activity.

TABLE 2

| | Recovered |
|---|---|
| Sample | Bacillus Activity |
| Aqueous Microbial Composition | 3.4 × 10⁹ CFU/mL |
| of Example 3 + 0% NaCl | |
| Aqueous Microbial Composition | 4.1 × 10⁹ CFU/mL |
| of Example 3 + 0.1% NaCl | |
| Aqueous Microbial Composition | 4.6 × 10⁹ CFU/mL |
| of Example 3 + 1.0% NaCl | |
| Aqueous Microbial Composition | 3.0 × 10⁹ CFU/mL |
| of Example 3 + 5.0% NaCl | |
| Aqueous Microbial Composition | 4.6 × 10⁹ CFU/mL |
| of Example 3 + 10.0% NaCl | |

### Example 4

Table 3 shows the generic formula prepared using the Bacillus concentrate from Example 1.

TABLE 3

| Material | Weight % |
|---|---|
| Bacillus mix from Example 1 | 10% |
| Surfactant | 5% |
| Solagum ™ AX¹ | 0.4% |
| CaSO₄ | 0.25% |
| Proxel ™ GXL² | 0.1% |
| Sterile Deionized Water | Balance |
| | to 100% |

1. Commercial name for a xanthan gum-acacia bum blend (Seppic)

2. Commercial name for a 20% solution of 1,2-benzisothiazolin-3-one in dipropylene glycol (Arch Chemicals).

Several different versions of the generic formula were prepared with the following surfactants: Triton™ CG110, Tergitol™ L-62, Tergitol™ 15-S-12, Ecosurf™ EH6, Tergitol™ XDLW, Synperonic™ 13/7, Synperonic™ 13/6, Ethyl hexanol alkoxylate, Agrilan® 755, Agrilan® 789, Ethyian™ NS-500LD.

These formulas were then placed in storage at ambient conditions. After 26 days, the top, middle, and bottom portions of the solutions were assayed for Bacillus activity:

TABLE 4
Bacillus titers in top, middle, and bottom portions
of the composition from Example 4

| | Bacillus Titer |
|---|---|
| Composition | (CFU/mL) |
| Control (no Surfactant or Solagum ™) | 7.6 × 10⁹ |
| Bottom Layer | |
| Control (no Surfactant or Solagum ™) | 1.0 × 10⁸ |
| Middle Layer | |
| Control (no Surfactant or Solagum ™) | 1.0 × 10⁷ |
| Top Layer | |
| Control (no Surfactant) Bottom Layer | 4.6 × 10⁹ |
| Control (no Surfactant) Middle Layer | 3.5 × 10⁹ |
| Control (no Surfactant) Top Layer | 1.4 × 10⁹ |
| Triton ™ CG110 Bottom Layer | 2.9 × 10⁹ |
| Triton ™ CG110 Middle Layer | 2.6 × 10⁹ |
| Triton ™ CG110 Top Layer | 2.0 × 10⁹ |
| Tergitol ™ L-62 Bottom Layer | 2.3 × 10⁹ |
| Tergitol ™ L-62 Middle Layer | 1.9 × 10⁹ |
| Tergitol ™ L-62 Top Layer | 2.6 × 10⁹ |
| Tergitol ™ 15-S-12 Bottom Layer | Too Numerous |
| | To Count |
| Tergitol ™ 15-S-12 Middle Layer | 4.4 × 10⁹ |
| Tergitol ™ 15-S-12 Top Layer | 2.9 × 10⁹ |
| Ecosurf ™ EH6 Bottom Layer | 4.0 × 10⁹ |
| Ecosurf ™ EH6 Middle Layer | 2.0 × 10⁹ |
| Ecosurf ™ EH6 Top Layer | 2.2 × 10⁹ |
| Tergitol ™ XDLW Bottom Layer | 3.1 × 10⁹ |
| Tergitol ™ XDLW Middle Layer | 3.3 × 10⁹ |
| Tergitol ™ XDLW Top Layer | 3.0 × 10⁹ |
| Synperonic ™ 13/7 Bottom Layer | 3.5 × 10⁹ |
| Synperonic ™ 13/7 Middle Layer | 3.5 × 10⁹ |
| Synperonic ™ 13/7 Top Layer | 3.5 × 10⁹ |
| Synperonic ™ 13/6 Bottom Layer | 2.5 × 10⁹ |
| Synperonic ™ 13/6 Middle Layer | 3.1 × 10⁹ |
| Synperonic ™ 13/6 Top Layer | 3.5 × 10⁹ |
| Ethyl-Hexanol-Alkoxylate Bottom Layer | 3.7 × 10⁹ |
| Ethyl-Hexanol-Alkoxylate Middle Layer | 2.0 × 10⁹ |
| Ethyl-Hexanol-Alkoxylate Top Layer | 4.4 × 10⁹ |
| Agrilan ® 755 Bottom Layer | 2.5 × 10⁹ |
| Agrilan ® 755 Middle Layer | 2.5 × 10⁹ |
| Agrilan ® 755 Top Layer | 2.5 × 10⁹ |
| Agrilan ® 789 Bottom Layer | 3.4 × 10⁹ |
| Agrilan ® 789 Middle Layer | 3.4 × 10⁹ |
| Agrilan ® 789 Top Layer | 4.7 × 10⁹ |
| Ethylan ™ NS-500LD Bottom Layer | 3.5 × 10⁹ |
| Ethylan ™ NS-500LD Middle Layer | 3.7 × 10⁹ |
| Ethylan ™ NS-500LD Top Layer | 4.1 × 10⁹ |

### Example 5

The best performing compositions from Example 4 are subjected to long term storage stability testing at 30° C./ambient RH, 32° C./65% RH, 35° C./ambient RH, and 40° C./75% RH.

The most physically and biologically stable compositions are then subjected to a microbial contamination challenge with a master inoculum comprising an equal mix of microbes isolated from various sources: Psuedomonas aeruginosa (Vietnam), P. aeruginosa (China), P. aeruginosa (Cincinnati, OH), P. taiwanensis (Vietnam), P. fluorescens (China), Klebsiella pneumoniae (Vietnam), Enterobacter sp (Vietnam), Escherichia coli (Vietnam), Serratia marsescens (China), Citrobacter freundii (China), Morganella morganii (China), wherein each isolate is grown individually in an overnight broth culture, then 10 mL of the broth culture is pelleted and the resulting biomass rinsed in sterile phosphate-buffered saline (PBS), and resuspended in 10 mL sterile PBS. 1 mL of rinsed, resuspended cells of each species are added together to produce a master inoculum. Titer is typically ≥3.0×10E9 CFU/mL. One mL of this master inoculum is dosed into 500 mL of each composition from Example 1, producing an initial inoculum challenge titer at T=0 of ˜6×10E6 CFU/mL. A composition is deemed to pass if the titer of the challenge inoculum is <10⁵ CFU/mL after 14-days incubation at 35° C.

### Example 6

### Test of Suspending Agents

The following suspending agents were tested: 1. Solagum™ AX (Shear thinning, mixture of xanthan gum and acacia gum); 2. Vanzan® D (xantham gum, glyoxal); 3, Van Gel® B (magnesium aluminum silicate); 4. Veegum® Ultra (magnesium aluminum silicate, titanium dioxide); 5. Veegum® Pure (magnesium aluminum silicate); 6. Veegum® D (magnesium aluminum silicate, Quartz); and 7. VANNATURAL (OMRI version of Veegum® D).

All the above listed suspending agents were formulated into the aqueous microbial compositions with the following formula: DI Water: 89.35 wt %; 10 wt % of a 1:1:1:1 blend of B. amyloliquefaciens, B. licheniformis, B. subtilis, and B. pumilus spores in water with acetic acid added to lower pH below 4 (total bacterial titer >4×10⁹CFU/mL); Calcium sulfate: 0.25 wt %; and Suspending agent: 0.4 wt %.

Settling was evident within a few days of making for all the samples except the one formulated with 0.4% Solagum™ AX. The level of Solagum™ AX was chosen to be 0.4% in subsequent studies as it is the maximum amount that can be added in order for the end product to be sprayable without clogging spray nozzles.

### Example 7

Table 5 shows a series of samples having high NaCl concentration.

TABLE 5

| | | | | | CL + 1% 2- | | |
|---|---|---|---|---|---|---|---|
| | Crop Liquid | | CL + 5% | CL + 1% | ethyl-hexanol | CL + 5% | CL + 0.5% |
| | (CL) − | CL/Solagum ^{™} | Synperonic ^{™}- | Synperonic ^{™}- | alkoxylate | Ecosurf ^{™} | Ecosurf ^{™} |
| | Control | (No Surfactant) | 13/6 | 13/6 | (EHA) | EH6 | EH6 |
| LOT# | R1808601 | R1808602 | R1808603 | R1808604 | R1808605 | R1808606 | R1808607 |
| A 1:1:1:1 | 10% | 10% | 10% | 10% | 10% | 10% | 10% |
| mix of | | | | | | | |
| Bacillus | | | | | | | |
| Endospores | | | | | | | |
| at pH ~6 | | | | | | | |
| containing | | | | | | | |
| 0.1 wt % | | | | | | | |
| Proxel ^{™} and | | | | | | | |
| 0.25 wt % | | | | | | | |
| CaSO₄ | | | | | | | |
| Proxel ^{™} | 0.1% | 0.1% | 0.1% | 0.1% | 0.1% | 0.1% | 0.1% |
| GXL | | | | | | | |
| Solagum ^{™} | 0 | 0.4% | 0.4% | 0.4% | 0.4% | 0.4% | 0.4% |
| AX | | | | | | | |
| Calcium | 0.25% | 0.25% | 0.75% | 0.25% | 0.75% | 0.25% | 0.25% |
| sulfate | | | | | | | |
| NaCl | 10% | 10% | 10% | 10% | 10% | 10% | 10% |
| Surfactant | 0 | 0 | 5% | 1% | 1% | 5% | 0.5% |
| Water | 79.65% | 79.25% | 74.25% | 78.25% | 78.25% | 74.25% | 78.75% |

In Table 5, the 1:1:1:1 blend of B. amyloliquefaciens, B. licheniformis, B. subtilis, and B. pumilus spores are suspended in water with a pH greater than 6. Total bacterial titer >4×10⁹ CFU/mL.

These samples were made and stored in 40° C./75% RH. After 24 hours, it was observed that samples with high dosage of surfactants (5%) showed settling, whereas those with low surfactant dosage (0.5 to 1%) looked suspended.

To test the ease of resuspension, each sample was inverted repeatedly until all the solids were off the bottom of the container. This test was conducted 78 days after storing at 40° C./75% RH. Table 6 shows the results of the inversion tests.

TABLE 6

| | | CL/Solagum ^{™} | CL + 5% | CL + 1% | | CL + 5% | CL + 0.5% |
|---|---|---|---|---|---|---|---|
| | CL − | (No | Synperonic- | Synperonic- | CL + 1% | Ecosurf ^{™} | Ecosurf ^{™} |
| | Control | Surfactant) | 13/6 | 13/6 | EHA | EH6 | EH6 |
| LOT# | R1808601 | R1808602 | R1808603 | R1808604 | R1808605 | R1808606 | R1808607 |
| Number | 20 | 4 | 5 | 3 | 3 | 3 | 2 |
| of | | | | | | | |
| inversions | | | | | | | |

The sample containing 0.4% Solagum™ AX and 0.5% Ecosurf™ EH6 is most easily resuspended with the least amount of physical agitation required.

Samples of crop liquid formulation (without NaCl) have been made with the combination 0.4% Solagum™ AX and 0.5% Ecosurf™ EH6 and are being stored at 40° C./75% RH. As of 40 days, there is no evident settling observed.

0% NaCl addition significantly affects the physical behavior of the formulations.

### Example 8

### Surfactant Test in Formulations with High Electrolyte Content

200ml samples were made with different surfactants. Each sample contained 0.5% surfactant. These samples were stored in 40° C./75% RH chamber. As of 24 hours, samples with surfactants indicated in items 1, 3-5, and 8 in Table 7 did not show settling, while the ones indicated in items 2, 6, 7, and 9-11 showed evidence of solids settling.

TABLE 7

| | | | Critical | | | |
|---|---|---|---|---|---|---|
| | | | Micelle | | Hydrophilic | |
| | | | Concentration | CMC | Lipophilic | Applications/ |
| | Nonionic | Chemical | (CMC) | (% in | Balance | Key |
| | Name | Composition | (ppm) | solution) | (HLB) | Benefits |
| 1. | TRITON ^{™} | Alkyl Polyglucoside | 1748 | 0.1748 | — | Biodegradable, |
| | CG 110 | | | | | agrochemicals |
| 2. | Tergitol ^{™}- | Secondary | — | | 7 | Anti-foaming, |
| | L-62 | Polyether polyol | | | | agent, insoluble |
| | | | | | | in water |
| 3. | Tergitol ^{™}- | Nonionic secondary | 104 | 0.0104 | 14.5 | Detergents, |
| | 15-S-12 | alcohol ethoxylate | | | | cleaners, paints, |
| | | | | | | dispersant |
| 4. | Ecosurf ^{™}- | Alcohol ethoxylate | 914 | 0.0914 | 12.5 | Biodegradable, |
| | EH6 | | | | | agrochemicals |
| 5. | Tergitol ^{™} | Alkyl EO/PO | — | | — | Agrochemicals, |
| | XDLW | copolymer | | | | good solubility in |
| | | | | | | presence of salts |
| | | | | | | & electrolytes |
| 6. | Synperonic ^{™} | Polyoxyethylene (7) | | | — | |
| | 13/7- | Tridecyl Alcohol | | | | |
| | LQ-(AP)- | | | | | |
| | ET47951 | | | | | |
| 7. | Synperonic ^{™} | Ethoxylated | | | 11 | |
| | 13/6- | branched C11-C14, | | | | |
| | LQ-(AP)- | C13-rich alcohols | | | | |
| | ET47020 | | | | | |
| 8. | Ethylan ^{™} | Butanol Ethoxylate/ | | | | Agrochemicals, |
| | NS-500LQ | Propoxylate | | | | dispersion, |
| | | | | | | emulsifying, |
| | | | | | | wetting |
| 9. | Agrilan ® | Soft anionic | | | | |
| | 755 | polymer | | | | |
| | | based on methyl | | | | |
| | | methacrylate | | | | |
| | | backbone grafted | | | | |
| | | with PEG | | | | |
| 10. | Tween ® 80 | Polysorbate 80 | | | | Organic |
| | | | | | | surfactant |
| 11. | Kinetic | 99-Proprietary | | | | OMRI listed, |
| | | blend of | | | | wetter, spreader, |
| | | polyalkyleneoxide | | | | surfactant |
| | | modified poly- | | | | |
| | | dimethylsiloxane | | | | |
| | | and nonionic | | | | |
| | | surfactants | | | | |

Each of the above samples was inverted until the contents on the bottom of the container were resuspended back into the liquid. This test was conducted 77 days after storing at 40°C./75% RH. Table 8 shows the results.

TABLE 8

| Surfactant | # of inversions |
|---|---|
| Control (contains | 4 |
| Solagum ™ AX, no | |
| surfactant) | |
| TRITON ™ CG 110 | 3 |
| Tergitol ™-L-62 | 3 |
| Tergitol ™-15-S-12 | 3 |
| Ecosurf ™-EH6 | 3 |
| Tergitol ™ XDLW | 3 |
| Synperonic ™ 13/7-LQ- | 3 |
| (AP)-ET47951 | |
| Synperonic ™ 13/6-LQ- | 3 |
| (AP)-ET47020 | |
| 2-ethyl-hexanol alkoxylate | 3 |
| Ethylan ™ NS-500LQ | 3 |
| Agrilan ® 789 Dry | 3 |
| Agrilan ® 755 | 3 |
| Tween ® 80 | 5 |
| Kinetic | 4 |

In these high electrolyte formulations, the surfactant has minimum effect on the ability to resuspend the product after settling.

### Example 9

### Testing the Effect of Different Salts on the Action of Solagum™ in the Formulation

Formulations with different salts —NaCl, KCl, and CaCl₂ were tested at different levels to see if there was any effect of salt type and concentration on the suspending power of Solagum™ AX. Table 9 lists the formulae of each sample, which was 200 ml.

TABLE 9

| | Crop | | | | | | |
|---|---|---|---|---|---|---|---|
| | Liquid | | | | | | |
| | Organic | | | | | | |
| | (CLO) − | CLO + | CLO + | CLO + | CLO + 10% | CLO + 5% | CLO + 10% |
| | Control | Solagum ^{™} | 5% NaCl | 5% KCl | KCl | CaCl₂ | CaCl₂ |
| Lot# | R1912801 | R1812802 | R1812803 | R1812804 | R1812805 | R1812806 | R1812807 |
| A 1:1:1:1 | 10% | 10% | 10% | 10% | 10% | 10% | 10% |
| Bacillus | | | | | | | |
| endospore | | | | | | | |
| mix at a | | | | | | | |
| pH < 4 | | | | | | | |
| containing | | | | | | | |
| 0.25 wt % | | | | | | | |
| CaSO₄ | | | | | | | |
| CaSO₄ | 0.25% | 0.25% | 0.25% | 0.25% | 0.25% | 0.25% | 0.25% |
| Sodium | 7.30% | 7.30% | 7.30% | 7.30% | 7.30% | 7.30% | 7.30% |
| bicarbonate | | | | | | | |
| Solagum ™ | 0 | 0.40% | 0.40% | 0.40% | 0.40% | 0.40% | 0.40% |
| Surfactant | 0 | 0.00% | 0.00% | 0.00% | 0.00% | 0.00% | 0.00% |
| Salt | 10% | 10.00% | 5.00% | 5.00% | 10.00% | 5.00% | 10.00% |
| Water | 72.450% | 72.050% | 77.050% | 77.050% | 72.050% | 77.050% | 77.050% |

These samples were inverted, and Table 10 shows the results.

TABLE 10

| | CLO − | CLO + | CLO + | CLO + | CLO + 10% | CLO + 5% | CLO + 10% |
|---|---|---|---|---|---|---|---|
| | Control | Solagum ^{™} | 5% NaCl | 5% KCl | KCl | CaCl₂ | CaCl₂ |
| Lot# | R1912801 | R18 12802 | R1812803 | R1812804 | R1812805 | R1812806 | R1812807 |
| Number of | 5 | 6 | 4 | 4 | 4 | 15 | 15 |
| inversions | | | | | | | |

### Example 10

### Process for Making Formulations Suitable for Organic Farming

One process for making formulations suitable for organic farming includes the following steps: (a) producing a Bacillus endospore raw material concentrate; (b) adding 1 wt % to 5 wt % of a 20 wt % acetic acid solution to the Bacillus concentrate such that the pH of the Bacillus concentrate is less than about 4.2; (c) adding sodium bicarbonate in an amount sufficient to adjust the Bacillus concentrate to pH 7, thereby creating a pH-adjusted Bacillus concentrate; (d) diluting the pH-adjusted Bacillus concentrate by water at a ratio of 1 to 9, thereby creating a diluted Bacillus suspension; and (e) adding NaCl to the diluted Bacillus suspension so that NaCl makes up about 10 wt % of the final formulation, which has a pH of 7. The acetic acid solution preserves the Bacillus endospore raw material against environmental microbial contaminants until ready for use in the final formulation. The final formulation can then be certified organic via the Organic Materials Review Institute (OMRI).

What is claimed is:

1. A stable aqueous microbial composition comprising:
at least one microbial species,
at least one preservative agent,
at least one suspending agent, and
a buffering agent in an amount sufficient to maintain the composition at a pH greater than 4.2.

2. The stable aqueous microbial composition of claim 1, wherein the composition is biologically stable at room temperature for at least a year.

3. The stable aqueous microbial composition of claim 1 or 2, wherein the composition is physically stable at room temperature for at least 30 days.

4. The stable aqueous microbial composition of claim 2, wherein the at least one preservative agent is in an amount sufficient to keep the composition biologically stable at room temperature for at least a year.

5. The stable aqueous microbial composition of any one of claims 1-4, comprising about 0.01 wt % to 10.0 wt % preservative agent.

6. The stable aqueous microbial composition of claim 3, wherein the at least one suspending agent is in an amount sufficient to keep the composition physically stable at room temperature for at least a year.

7. The stable aqueous microbial composition of any one of claims 1-6, comprising about 0.01 wt % to 10.0 wt % suspending agent.

8. The stable aqueous microbial composition of any one of claims 1-7, wherein the at least one microbial species comprises at least one species selected from Bacillus, Pseudomonas, Trichoderma, Azospirillum, Azotobacter, Methylobacterium, Enterobacter, Alcaligenes, Arthrobacter, Burkolderia, or Serratia.

9. The stable aqueous microbial composition of claim 8, wherein the at least one Bacillus species is selected from Bacillus subtilis, Bacillus subtilis 34KLB, Bacillus amyloliquefaciens, Bacillus licheniformis, Bacillus pumilus, Bacillus mojavensis, Bacillus thuringiensus, Bacillus cereus, Bacillus megaterium, and a combination thereof.

10. The stable aqueous microbial composition of claim 9, wherein the at least one Bacillus species is a combination of Bacillus subtilis, Bacillus amyloliquefaciens, Bacillus licheniformis, and Bacillus pumilus.

11. The stable aqueous microbial composition of claim 10, wherein Bacillus subtilis, Bacillus amyloliquefaciens, Bacillus licheniformis, and Bacillus pumilus are present at equal colony-forming unit (CFU) count per milliliter of the composition.

12. The stable aqueous microbial composition of any one of claims 1-11, having a microbial concentration of at least 1×10⁹ CFU/mL.

13. The stable aqueous microbial composition of any one of claims 1-12, wherein the at least one preservative agent is selected from a modified isothiazolin compound, an ester of p-hydroxybenzoic acid, a modified quaternary amine, a modified urea, a glycerin derivative, 2-bromo-2-nitro-1,3-propanediol, a natural oil, an organic acid having a molecular weight of no more than 200 and at least one pKa greater than 4.2, an inorganic salt, and a combination thereof.

14. The stable aqueous microbial composition of claim 13, wherein the modified isothiazolin compound is 1,2-benzisothiazolin-3-one, methylisothiazolinone, methylchloroisothiazolinone, benzisothiazolinone, or a combination thereof.

15. The stable aqueous microbial composition of claim 13, wherein the ester of p-hydroxybenzoic acid is methylparaben, ethylparaben, propylparaben, or a combination thereof.

16. The stable aqueous microbial composition of claim 13, wherein the modified quaternary amine is benzethonium chloride or cetylpyridinium chloride, or a combination thereof.

17. The stable aqueous microbial composition of claim 13, wherein the modified urea is diazolidinyl urea, imidazolidinyl urea, or a combination thereof.

18. The stable aqueous microbial composition of claim 13, wherein the glycerin derivative is ethylhexylalycerin.

19. The stable aqueous microbial composition of claim 13, wherein the natural oil is grapefruit seed extract, tea tree oil, thyme oil, lemongrass oil, oregano oil, rosemary oil, lavender oil, or a combination thereof.

20. The stable aqueous microbial composition of claim 13, wherein the organic acid is acetic acid, citric acid, ascorbic acid, sorbic acid, propanoic acid, butyric acid, oxalic acid, succinic acid, malic acid, tartaric acid, fumaric acid, aconitic acid, dipicolinic acid, an amino acid, or a combination thereof.

21. The stable aqueous microbial composition of claim 20, wherein the organic acid is acetic acid, citric acid, ascorbic acid, sorbic acid, or a combination thereof.

22. The stable aqueous microbial composition of claim 13, wherein the inorganic salt is selected from sodium chloride, potassium chloride, magnesium chloride, calcium chloride, sodium sulfate, potassium sulfate, magnesium sulfate, calcium sulfate, and a combination thereof.

23. The stable aqueous microbial composition of claim 14, wherein the modified isothiazolin compound is 1,2-benzisothiazolin-3-one.

24. The stable aqueous microbial composition of claim 23, having about 0.01 wt % to about 1.0 wt % 1,2-benzisothiazolin-3-one.

25. The stable aqueous microbial composition of claim 13, wherein the at least one preservative agent comprises an organic acid having a molecular weight of no more than 200 and at least one pKa greater than 4.2, and an inorganic salt, and wherein the microbial composition is suitable for use in organic farming.

26. The stable aqueous microbial composition of any one of claims 1-25, wherein the at least one suspending agent is a polymer, a surfactant, or a combination thereof.

27. The stable aqueous microbial composition of claim 26, wherein the polymer is selected from xanthan gum, guar gum, acacia gum, carboxymethylcellulose, sodium polyacrylate, polyethylene glycol, an ethylene oxide-propylene oxide (EO-PO) block copolymer, a modified starch, a modified polyacrylate, a modified methyl methacrylate, a polyethylene imine, sodium polyaspartate, poly-γ-glutamic acid, and a combination thereof.

28. The stable aqueous microbial composition of claim 27, wherein the polymer is a blend of xanthan and acacia gums.

29. The stable aqueous microbial position of any one of claims 26-28, having about 0.1 wt % to about 1.0 wt % polymer.

30. The stable aqueous microbial composition of claim 26, wherein the surfactant has a cloud point from about 30° C. to about 80° C., and hydrophilic-lipophilic balance from about 5 to about 15.

31. The stable aqueous microbial composition of claim 26, wherein the surfactant is selected from a primary alkyl alcohol ethoxylate, a secondary alkyl alcohol ethoxylate, a primary alkyl alcohol propoxylate, a secondary alkyl alcohol propoxylate, and a combination thereof.

32. The stable aqueous microbial composition of claim 31, wherein the surfactant is a C-13 branched primary alcohol with average ethoxylation of 5 to 10.

33. The stable aqueous microbial composition of any one of claims 26 and 30-32, having about 0.1 wt % to about 10 wt % surfactant.

34. The stable aqueous microbial composition of any one of claims 1-33, wherein the buffering agent is selected from sodium bicarbonate, sodium carbonate, calcium carbonate, a synthetic amino acid, a non-synthetic amino acid, and a combination thereof.

35. The stable aqueous microbial composition of any one of claims 1-34, wherein the composition is at a pH of about 4.3 to about 8.5.

36. The stable aqueous microbial composition of claim 8, wherein the at least one Pseudomonas species is selected from Pseudomonas fluorescens, Pseudomonas putida Pseudomonas aeruginosa, and a combination thereof.

37. The stable aqueous microbial composition of any one of claims 1-36, coated onto a fertilizer.

38. The stable aqueous microbial corn position of any one of claims 1-36, coated onto rice, corn, soybean, onion, sugar cane, tomato, barley, lettuce, wheat, potato, legumes, or grass seed.

39. A fertilizing composition comprising a fertilizer coated with the stable aqueous microbial composition of any one of claims 1-36.

40. The fertilizing composition of claim 39, wherein the fertilizer is an organic fertilizer.

41. The fertilizing composition of claim 40, wherein the organic fertilizer comprises fish meal, bird guano, livestock manure, compost, and rock phosphate.

42. A method for stabilizing at least one microbial species in an aqueous microbial composition, the method comprising adding to the aqueous microbial composition (a) at least one preservative agent, (b) at least one suspending agent, and (c) a buffering agent in an amount sufficient to maintain the composition at a pH greater than 4.2.

43. A method for fertilizing a crop, the method comprising contacting the crop with the stable aqueous microbial composition of any one of claims 1-36.

44. The method of claim 43, wherein the crop is an organic crop.

45. The method of claim 43 or 44, wherein the crop is selected from rice, corn, soybean, onion, sugar cane, tomato, potato, barley, wheat, legume, lettuce, and grass.

46. The method of any one of claims 43-45, wherein the crop is contacted with the stable aqueous microbial composition 1-3 times during growth season.

47. The method of any one of claims 43-46, wherein contacting the crop comprises applying the aqueous microbial composition to soil and/or an irrigation system.

48. The method of any one of claims 43-47, further comprising mixing the aqueous microbial composition with a fertilizer prior to contacting the crop.
